(19) United States
(12) Patent Application Publication
(10) Pub. No.: US 2004/0170757 A1
(43) Pub. Date: Sep. 2, 2004

(54) Method for depositing a spot product of a product of interest, and use for isolating and/or determining an analyte

(76) Inventors: Agnes Perrin, Lyon (FR); Alain Theretz, Ecully (FR); Thierry Delair, Echalas (FR); Bernard Mandrand, Villeurbanne (FR)

Correspondence Address: Oliff & Berridge, PO Box 19928, Alexandria, VA, 22320, US

(21) Appl. No.: 10/475,873

(22) PCT Filed: Apr. 25, 2002
(86) PCT No.: PCT/FR02/01444

(30) Foreign Application Priority Data
Apr. 26, 2001 (FR) 01/05639

(51) Int. Cl. B05D 5/12

(52) U.S. Cl. 427/127; 427/598

(57) ABSTRACT

Process for depositing, on a substrate (1), a product of interest (2), according to a basic area (3) which has a low value, referred to as a “spot”, according to which process:

(a) a liquid medium (4), comprising a vehicle and the product of interest (2), is prepared or is available;

(b) a drop (5) is formed from the liquid medium, and said drop is placed on the surface (1a) of the substrate, in contact with the liquid medium;

(c) the vehicle is removed from the drop (5), for example by drying, so as to allow said spot (3) to remain;

characterized in that, in combination:

(1) a magnetic support (6), distributed in the vehicle, is prepared or is available;

(2) the product of interest (2) is bound to the magnetic support (6), as a result of which the liquid medium, from which the drop (5) is formed, comprises transporting particles (7),

(3) at least during the removal of the vehicle from the drop (5), a magnetic field (8) is generated which crosses the surface (1a) of the substrate (1), as a result of which the spot (3) obtained comprises transporting particles (7), and therefore the product of interest (2).

The present invention relates generally to the deposition, for example in the dry state, on a substrate, of at least a predetermined amount, or dose, of at least one product of interest, distributed at the surface of the substrate and delimited according to a basic area, which has a low value, in particular at most equal to 35 mm², and preferably between 0.001 and 3 mm² , referred to as a “spot”.

Various techniques require such a deposition, in the dry state, among which mention may be made of:

the printing of a paper-type substrate by inkjet, in which case the product of interest is a pigment or a dye, and the juxtaposition of the spots of different colour and/or intensities reproduces any image or characters of an alphabet,

the isolation and/or determination (qualitative and/or quantitative) of an analyte, in particular of a biomolecule, especially a biomacromolecule such as a nucleic acid or a protein, using reaction wells, for example on a microplate, in which case the product of interest is a reagent for capturing the analyte, for example a ligand which binds specifically to the analyte; in this case, the spot(s) obtained is (are) arranged, for example, on the bottom of one or more microtitration wells.

Conventionally, whatever the technique involved, such a spot is obtained according to the following general process:

a) a liquid (or fluid) medium comprising a vehicle, for example a solvent, and the product of interest homogeneously distributed (dispersed and/or dissolved) in said vehicle is prepared or is available,

b) a drop is formed from the liquid medium, according to any appropriate technique, the volume of which drop is determined in relation to the predetermined amount of the product of interest to be deposited in the spot, and the drop is placed or deposited, with or without acceleration (for example by gravity), onto the surface of the substrate, a very limited area of which is then in contact with the liquid medium of the drop,

c) the vehicle is removed at least partially, or even totally, from the drop by any appropriate means, for example by drying, while it remains on the surface of the substrate, so as to allow the desired spot, consisting of or comprising the product of interest, to remain on said substrate, covering the surface of the latter.

Such a process comprises a substantial difficulty, which has in particular been identified and analysed in the inkjet printing field; cf. U.S. Pat. No. 5,695,820.

Due to the evaporation and/or condensation of the vehicle, undergoing elimination, or for other reasons, the surface tension between the liquid medium and the outside varies according to the interface of the drop, which generates an internal microcirculation of the liquid medium, the effect of which is to concentrate the product of interest over the periphery of the drop.

In the inkjet printing field, this phenomenon, known as the MARANGONI effect, has the effect of conferring on each spot a form of halo.

In the field of determination (qualitative and/or quantitative) of a biomolecule, the effect of this phenomenon is to generate a deposit of the ligand in the shape of a crown, in which the distribution and the concentration of ligand can be neither controlled nor reproducible, which is contrary to the reliability sought in any analytical method, in particular in the molecular biology field.

Prior to the present invention, the applicant has carried out various tests in order to eliminate or limit the MARANGONI effect in the process of formation of a spot of a ligand on the bottom of a well of an analytical microplate:

1) by cooling the substrate, the MARANGONI effect is certainly limited, but the drop does not dry or requires a drying time which is incompatible with an automated or industrial process;

2) conversely, when heating the substrate, so that the product of interest does not have the time to migrate to the edge of the drop, the formation of a spot in the form of a halo is nevertheless observed;

3) when drying the drop in a humid atmosphere, the disadvantages according to 1) are observed;

4) when increasing the viscosity of the liquid medium, with a suitable additive, the drop dries poorly or not at all.

The object of the present invention is therefore to remedy the MARANGONI effect by thwarting the latter.

According to the present invention, it has been discovered that the MARANGONI effect virtually ceases, in any process of formation of a spot from a drop, once the following operating conditions are used in combination:

1) a magnetic support distributed homogeneously in the form of particles in the vehicle is prepared or is available;

2) the product of interest is bound to the magnetic support, as a result of which the liquid medium, from which the drop is formed, comprises transporting particles distributed in the vehicle, each one comprising both the magnetic support and the product of interest;

3) at least during the removal of the vehicle from the drop, a magnetic field is generated which crosses the surface of the substrate according to a section comprising the area of contact between the drop and the substrate, as a result of which the spot obtained comprises the transporting particles and therefore the product of interest, for example in the dry state, according to a homogeneous surface distribution.

By virtue of the invention, and as shown by the experimental protocol described hereinafter in the field of determination of an analyte of the biomolecule type, a homogeneous spot is obtained in which virtually all the product of interest is well distributed at the surface, via the transporting particles having exactly the same distribution at the surface of the spot.

By virtue of the action of the magnetic field, better retention of the spot at the surface of the substrate is also noted, doubtless due to penetration or anchoring of the transporting particles in the surface layer of the substrate.

Such an advantage is important for determining an analyte of the biomolecule type, since the spot is often washed, sometimes several times, before the analyte bound to the ligand is determined by any appropriate method, for example with a labelled reagent.

Throughout the present description, the following vocabulary is explained.

The term “isolate” or “isolation” is intended to mean, generically, any technique for separating an analyte, but also for enriching in or concentrating said analyte in any liquid fraction or portion containing it. However, it is also intended to mean, possibly jointly with the preceding definition, any technique for determining the analyte, in the sense of detection and/or quantification thereof, from the liquid medium containing it.

The term “analyte” is intended to mean any entity, in particular biological entity, to be isolated. Among the analytes considered hereinafter by the present invention, mention will be made of cells, organelles, viruses and bacteria, antibodies, antibody fragments, antigens, haptens, lectins, sugars, ribonucleic acids, deoxyribonucleic acids, proteins, in particular protein A or protein G, hormones, hormone receptors and, in general, any natural or synthetic molecules or macromolecules, or the like to be determined, i.e. to be detected and/or quantified.

The term “ligand” is intended to mean an element capable of forming, via a chemical or physical attachment, a complex with an analyte. By way of example of ligands, mention may be made of antibodies, antibody fragments, antigens, haptens, lectins, sugars, ribonucleic acids and deoxyribonucleic acids, proteins, in particular protein A or protein G, hormones, hormone receptors, biotin, avadin or streptavidin and, in general, natural or synthetic ligands, and modified ligand analogues which can compete with the ligands.

The term “support” is intended to mean any polymeric, inorganic or metal support. By way of example of polymeric supports, mention may be made of plastic supports based on polystyrene, poly(meth)acrylates, polybutadiene, polypropylene or others, alone or in the form of copolymers. By way of example of inorganic supports, mention may be made of silicon oxide, silicon, mica, glass, quartz, etc. By way of example of metal supports, mention may be made of gold, silver, titanium oxide, vanadium oxide, etc.

The ligands can be immobilized on the support either by simple adsorption onto the native or modified support, or via a chemical (functionalization) or physical reaction making it possible to modify the surface of the support and thus allow the attachment of the ligand via covalent bonds, or other conventional means well known to those skilled in the art.

The term “particle” is intended to mean any particle of a polymeric, inorganic or metal support onto which it is possible to graft a ligand. In particular, particles which can be separated magnetically are considered to fall within the field of the present invention. From the definition above emerge particles which are small in size, in particular superparamagnetic particles, for which the rate of sedimentation under the effect of gravity is less than thermal agitation, but which can constitute aggregates via any process making it possible to bring them together, or to assemble them on larger particles which can be separated magnetically.

By way of example of polymeric particles, mention may be made of the particles obtained by emulsion polymerization, such as latex beads, or particles which are larger, but magnetic.

By way of example of metal particles, mention may be made of ferro-, ferri-, para- or superparamagnetic particles, which may or may not be coated with natural or synthetic polymers, the composition of which comprises iron or other metals such as cobalt, nickel or the like, alone or in the form of alloys, but which are magnetic.

By way of example of inorganic particles, mention may be made of particles based on silica or on silicon, which may or may not be magnetic.

The magnetic particles used by the present invention can be divided into two categories, namely particles with a relatively large diameter, for example of the order of a micron or a few microns, and those with a relatively small diameter, for example of the order of a few tens of nanometres, and in the colloidal state.

The magnetic particles with a relatively large diameter, when they are place in a magnetic field, move in the direction of the place where the field is highest and at a rate sufficient to be separated from their medium via this means.

By way of example, mention may be made of the particles described in document EP-A-0 125 995. They are obtained by precipitation of ferrous and ferric salts in basic medium, followed by a silanization reaction in methanol. Their final diameter is between 0.1 and 1.5 μm and their density is 2.5 g/cm³. Similarly, the particles described in documents EP-A-0 106 873, EP-A-0 585 868 and U.S. Pat. No. 5,356,713 are obtained by various polymerization processes, or alternatively those described in document U.S. Pat. No. 4,297,337 use a porous glass matrix in which magnetic pigments are dispersed. Other patents also describe the use of particles which are small in size but deliberately aggregated in order to increase the magnetic mass, as in document U.S. Pat. No. 5,169,754. The article by P. A. Risen et al, Protein Expression and Purification, 6 (1995), 272-277 also describes magnetic gels.

When placed in a magnetic field, all these relatively large particles engender a movement in the direction of the place where the field is the most intense. A simple permanent magnet or equivalent assemblies as described, for example, in document EP-A-0 317 286 can be used. These particles are commonly used to separate cells or molecules, and also in immunoassays as described in document EP-A-0 528 708.

The magnetic particles with a relatively small diameter are virtually not attracted by a simple permanent magnet within reasonable periods of time. These particles are in particular widely used for the magnetic separation of cells. For example, those described in document U.S. Pat. No. 4,230,685 are obtained by emulsifying a mixture of albumin, protein A and Fe₃O₄ particles 15-20 nm in diameter, and can immobilize antibodies via the protein A. Document U.S. Pat. No. 4,452,773 describes another type of particle, obtained by precipitation of ferrous and ferric salts in basic medium, and in the presence of a polysaccharide. These particles can immobilize antibodies, oligonucleotides, lectins or other biomolecules, by coupling to the polysaccharide, using known grafting methods. Their use has often been repeated, as in documents U.S. Pat. No. 5,543,289 or WO-A-88/00060, or they are used in particular applications such as those described in documents FR-A-2 710 410 and FR-A-2 732 116. Document U.S. Pat. No. 4,795,698 describes a modification of the Molday procedure, by replacing, for example, the polysaccharide with another polymer which is protein in nature. The proteins present at the surface of the particles can thus be used for the subsequent immobilization of antibodies by coupling methods known to those skilled in the art.

These particles with a relatively small diameter require the use of particular assemblies which make it possible to locally increase the magnetic field gradient. This technique is known by those skilled in the art as HGMS (for High Gradient Magnetic Separation) and uses a device consisting, for example, of an open container filled with a matrix of metal fibres or grains. When placed in an external magnetic field, this device makes it possible to obtain a very large field gradient at the very surface of the fibres. Even superparamagnetic particles of limited sizes can be retained on such a device, if the network of fibres is sufficiently closed up and if the path of a particle takes it close to the matrix. By way of example, such devices are described in documents U.S. Pat. No. 4,375,407, U.S. Pat. No. 5,543,289, WO-A-96/26782, WO-A-96/26011 or U.S. Pat. No. 5,186,827, and publications such as that by B. L. Hirschbein et al. (CHEMTECH, March 1982, pp. 172-179). Commercially available assemblies can also be found, for example under the name MACS column from Miltenyi Biotec (Bergisch Gladbach, Germany).

In accordance with the present invention, by way of example, the product of interest is a ligand, which may be an oligonucleotide for capturing a target nucleic acid.

Preferably, the product of interest is bound to the magnetic support, in the form of particles, by functionalization of the support and then bonding, for example covalent bonding, between the functionalized support and the product of interest.

By way of example, and as described hereinafter in the experimental protocol, the substrate is a wall of a microtitration or microanalysis well.

Preferably, and by way of example, the process according to the invention falls within the realms of a method for isolating, for example for determining, an analyte and, in such a case, the product of interest is a ligand specific for the analyte and the substrate is, for example, the wall of a microtitration well, as obtained at the end of a process according to the invention.

In such a case, use is therefore made of a device for isolating, for example for determining, an analyte, comprising or incorporating at least one well, at least a part of whose wall, for example the bottom thereof, constitutes a substrate on which is deposited at least one spot obtained by a process according to the invention.

The present invention is now described with reference to the attached drawing, in the form of an explanatory diagram, in which:

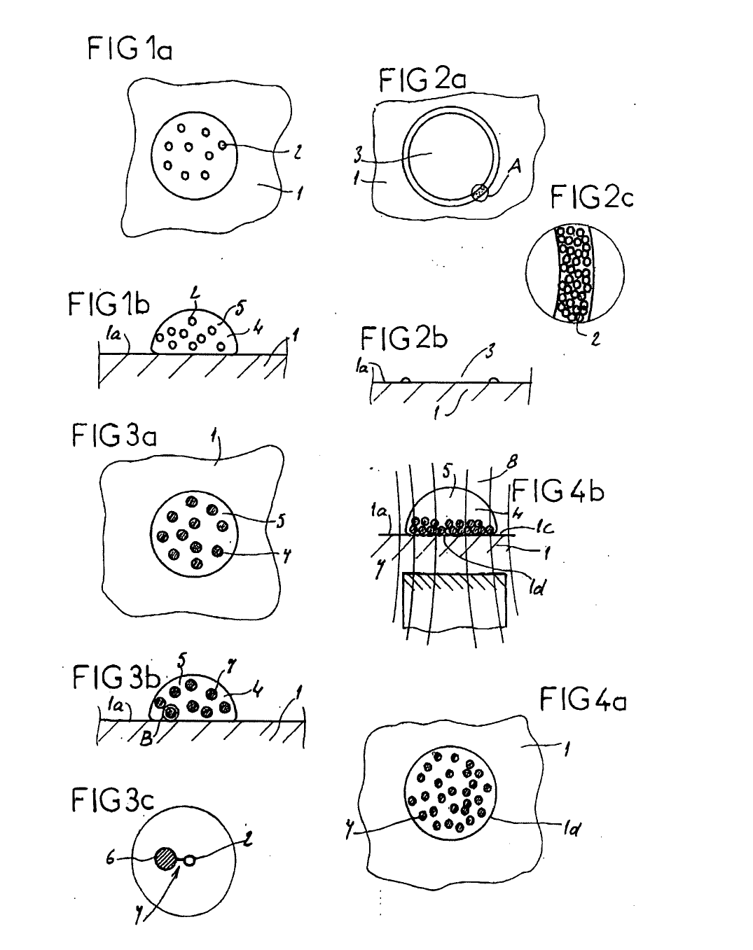

FIGS. 1 and 2 represent two steps of a process of deposition according to the prior art, the index a being reserved for a view from above and the index b being reserved for a sectional view;

FIG. 2c represents on a magnified scale a detail A of FIG. 2a,

FIGS. 3, 4 and 5 represent three steps of a process of deposition according to the present invention; as previously, the index a is reserved for a view from above and the index b for a sectional view; FIG. 3c represents a detail B, on a magnified scale, of FIG. 3b, by way of example,

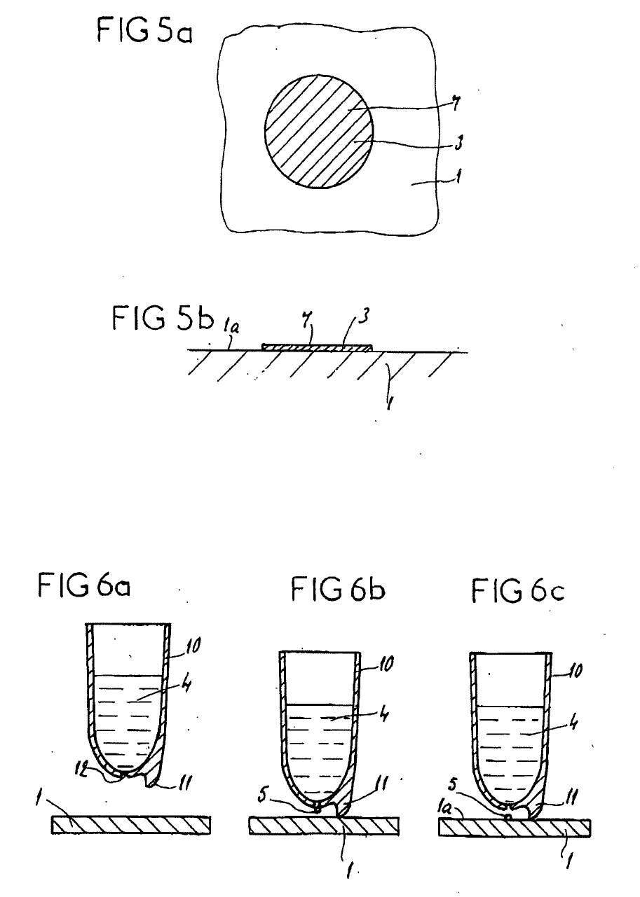

FIGS. 6a to 6c represent the method of forming and of placing a drop, as required by a process of deposition according to the invention.

In accordance with the prior art and with FIGS. 1 and 2, it involves depositing, in the dry state, on a substrate (1) at least a predetermined amount of at least one product of interest, distributed at the surface (1a) of the substrate and delimited according to a basic area (3), having a small value, for example having a diameter of the order of 0.3 mm.

In accordance with this prior process:

a) a liquid medium (4), comprising a vehicle, for example a solvent, and the product of interest (2) homogeneously distributed (dissolved and/or suspended) in the vehicle, is prepared or is available;

b) a drop (5) is formed from the liquid medium by any appropriate means, for example with those described hereinafter with reference to FIG. 6, the volume of which drop is determined in relation to the predetermined amount of the product of interest to be deposited, and this drop is placed onto the surface (1a) of the substrate, in contact with the liquid medium (cf. FIG. 1);

c) the vehicle is removed at least partially, or even totally, from the drop (5), while it remains on the surface (1a) of the substrate (1), for example by drying, so as to allow the spot (3) to remain, for example in the dry state; as shown in FIG. 2, in practice, this spot is in the shape of a halo or crown, consisting of a mass of the product of interest (2).

As shown in FIGS. 6a to 6c, in order to form the drop (5) from the liquid medium (4), the following procedure is, for example, carried out:

the liquid medium (4) is loaded into a reservoir (10), equipped, at its bottom end, with an orifice (12) of suitable size so that the medium (4) does not flow by gravity, when the reservoir (10) is at rest;

the reservoir (10) is moved from its starting position (cf. FIG. 6a) to an end position (cf. FIG. 6b), determined by the contact between the stop (11) (on the reservoir (10) side) and the substrate (1);

when the movement of the reservoir (10) is stopped, the mechanical shock thus created on said reservoir makes it possible to extract, via the orifice (12), a drop of the liquid medium (4), which drop will move through the air before being deposited on the substrate (1) (cf. FIG. 6c).

The formation and the deposition of the drop can be carried out according to any process different from that described above, for example by deposition from a capillary, by simple contact between the latter containing the liquid medium and the substrate.

According to the invention, in accordance with FIGS. 3 to 5, and unlike the process according to the prior art:

1—a magnetic support (6) distributed homogeneously in the form of particles in the vehicle is prepared or is available (cf. FIG. 3);

2—the product of interest (2) is bound, by any appropriate means, to the magnetic support (6), as a result of which the liquid medium (4), from which the drop (5) is formed, comprises transporting particles (7) distributed in the vehicle, each one comprising both the magnetic support (6) and the product of interest (2) (cf. FIGS. 3a to 3c);

3—at least during the at least partial removal of the vehicle from the drop (5), a magnetic field (8) is generated with a magnet chosen and positioned such that the magnetic field (8) crosses, virtually perpendicularly, the surface (1a) of the substrate (1), which is immobile, according to a section (1c) comprising, and therefore larger than, the area of contact (1d) between the drop (5) and the substrate (1) (cf. FIGS. 4a and 4b); after drying, if necessary complete drying, the spot (3) obtained comprises the transporting particles (7), in the dry state, these transporting particles being uniformly distributed within the spot (3), as shown in FIGS. 5a and 5b.

The present invention and its advantages are demonstrated by the experimental protocol hereinafter, with the vocabulary of the claims corresponding in the following manner to that of said protocol:

the magnetic latex beads are an example, among others, of a magnetic support divided up in the form of particles;

the magnet used generates the magnetic field for implementing the invention;

the bottom of each microtitration well constitutes the substrate;

the analyte is a nucleic acid target, for example a post-RT-PCR amplicon;

the product of interest is a ligand, namely a capture oligonucleotide which can be immobilized on any support via a reactive couple, namely streptavidin, biotin; this oligonucleotide is specific, i.e. complementary to the nucleic acid target, or not specific for the analyte previously exemplified;

the transporting particles correspond to the product of conjugation, or conjugate, between the magnetic particles and the abovementioned capture oligonucleotide;

the analyte bound to the capture oligonucleotide is detected by any appropriate means, for example with a labelled reagent which binds to the immobilized analyte.

### EXAMPLE 1

### Magnetic Latex Bead Deposits. Influence of the Presence of a Magnet Under the Deposition Surface on the Morphology of the Spot

Preparation of the Magnetic Latex Beads

A solution of magnetic latex beads (diameter=300 nm, solids content=0.1%) is prepared in a 0.2M borate buffer, pH 9.2, and is commercially available from the French company Ademtech, in Pessac (France), under the reference AD F112/E212E/P212.

This solution is introduced into a device as described with reference to FIGS. 6a to 6c, which can be adapted to a microtitration plate (Nunc Maxisorb, polystyrene support, 96 wells) . This system makes it possible to eject drops towards the bottom of a well, through a nozzle with a diameter of 50 μm, after a path through the air of approximately 500 μm.

Deposition Under a Magnetic Field

Placed under the bottom of the well of this plate, fixed in position, is a cylindrical magnet, developing a magnetic field which crosses the bottom of the well in a perpendicular manner, the cylindrical head of which magnet has a surface area exceeding the cross section of the well (diameter=12 mm). The latex beads are deposited in the form of spots at the bottom of the surface of this well, and are left to dry for approximately 10 minutes.

Deposition Without a Magnetic Field

The same type of deposition is performed in the absence of a magnet under the well.

Analysis

The deposits are analysed under an optical microscope at 5× magnification, and with brightfield. An image of each spot is acquired using a CCD camera attached to the microscope tube. Associated with each pixel of this image is a level of grey, from 0 (black) to 256 (white), which is lower the higher the density of material. A cross section of the spots thus makes it possible to determine the distribution of the particles according to the deposition method.

Results

In the absence of a magnet, the latex beads are preferentially distributed at the periphery of the spot, in the form of a halo (as in FIG. 2c), during the drying. A highly heterogeneous particle distribution is observed. On the other hand, the presence of a magnet under the deposition surface, during drying, which induces a strong magnetic attraction perpendicularly to the surface, avoids the convectional movement of the particles towards the edge of the spot. A uniform distribution of the particles is observed at the end of drying.

Strong washing shows that the spots are not affected and the particles are very strongly adsorbed onto the surface at the end of the washing. This makes it possible to solve an important point observed during deposition of non-magnetized particles: the crown (halo) which they form on drying can be torn away during the washings, to such an extent that this ring is now only partial.

### EXAMPLE 2

### Detection of Nucleic Acid Targets on Spots of Magnetic Particles. Advantage of Depositing Magnetic Particles Compared to Direct Deposition

Direct Deposition

A 1 mg/ml streptavidin solution is prepared in 0.2M borate buffer, pH 9.2. This is deposited in the form of spots in several wells of a microtitration plate using the deposition device described above and equipped with a head comprising four capillaries for simultaneously depositing four spots, the diameter of which is in the region of 1 mm. As mentioned above, such spots can be obtained by depositing drops using simple contact between capillary tubes and the bottom of the well. The spots are left to dry for 15 minutes and are then rinsed with a PBS-0.05% Tween solution.

Immobilization of the biotinylated capture oligonucleotides: 30 μl of a solution at 5×10¹⁵ copies/ml, in PBS buffer, of oligonucleotides which are specific (A) or not specific (B) for a nucleic acid target, and which are both 5′-biotinylated, are introduced into the functionalized wells. The immobilization reaction takes place for 30 minutes at 37° C. with shaking. The wells are then rinsed in PBS-Tween buffer.

Oligonucleotide A has the sequence:

5′BIOTIN-TTG GAT TGG CCA TCC AGT

oligonucleotide B has the sequence:

5′BIOTIN-CAT GTG CTA CTT CAC CAA CGG

Deposition via Magnetic Particles

The starting material is a magnetic emulsion (Ademtech, Pessac, France, reference AD F112/E212E/P212).

The particles of this emulsion are then functionalized on the surface by covalent grafting of streptavidin using a heterobifunctional coupling agent, namely carbodiimide.

They are then washed by magnetization and taken up in PBS buffer at a solids content of 0.2%.

Attachment of the biotinylated oligonucleotides: 5×10¹⁴ copies of a solution of specific (A) or non-specific (B) biotinylated oligonucleotides are added to 100 μl of streptavidin-magnetic particles. The immobilization reaction takes place for 30 minutes at 37° C. with shaking. The latex beads are then washed by magnetization and taken up in borate buffer, before being deposited in the form of spots in the wells of a microplate with the capillary depositing device described above. Magnets are placed under some of the wells during deposition and during drying of the spots.

Capture and Detection on a Spot of Fluorescent Nucleic Acid Targets

A target oligonucleotide having the following sequence:

5′ FITC-ACT GGA TGG ATC CAA is therefore labelled at its 5′ end with fluorescein, with a concentration of 7×10¹⁴ copies/ml. This fluorescent oligonucleotide is complementary or not complementary to oligonucleotides A or B, respectively. 30 μl of this solution are deposited into each of the activated wells. The hybridization reaction takes place for 30 minutes at 37° C. with shaking. The wells are then rinsed in PBS-Tween buffer and then in PBS buffer. They are analysed under a fluorescence microscope in the presence of 50 μl of PBS in each well.

Results

The Case of Direct Deposition

No fluorescent signal could be detected in the case of direct deposition under the conditions used. It is probable that the amount of streptavidin adsorbed onto the surface of the microplate is insufficient to then allow efficient capture of the labelled targets.

The Case of Deposition via Magnetic Particles

In both cases, an image of the fluorescent spots is obtained in the presence of the specific oligonucleotide. However, the morphology of the image is very different depending on whether the deposition took place in the presence or in the absence of the magnet under the microplate.

In the absence of a magnet, the same heterogeneous distribution of the signal as that described in Example 1 in the absence of a magnet is observed, i.e. a considerable concentration of the magnetic particles, and therefore of the capture oligonucleotides, at the periphery of the drop.

In the presence of a magnet, the fluorescence signal uniformly distributed within the spot, by virtue of the homogeneous distribution of captures sites.

The signal generated by the spot is analysed using a simple image analysis which consists in calculating the mean level of grey within a window defined by the user. A number of pixels pᵢ is associated with each level of grey nᵢ. The mean level of grey of a window is defined by:

$$N = \frac{\sum {n}_{i} {P}_{i}}{\sum {p}_{i}}$$

The levels of fluorescence generated on the spots of magnetic particles were thus analysed.

The advantage of depositing magnetic particles under a magnetic field is clearly apparent. It is possible, in this case, to clearly differentiate the “specific” spots from the “non-specific” spots, whereas this is not possible in the case of the spots of non-magnetic particles.

### EXAMPLE 3

### Detection of post-RT-PCR Amplicons on Spots of Magnetic Latex Beads

Amplification of the Nucleic Acid Targets

Sabin3 poliovirus RNA (7 kB), described via its sequence in GENBANK No. X00596, is amplified by RT-PCR (Access kit from Promega), in the presence of biotinylated primers which make it possible to obtain DNA amplicons labelled with biotin at their 5′ end. The amplicons (200 bases), described according to the sequence below, are controlled (amount and size) on an agarose gel:

cc tccggcccct
gaatgcggct aattctaacc atggagcagg cagctgcaac
ccagcagcca gcctgtcgta acgcgcaagt ccgtggcgga
accgactact ttgggtgtcc gtgtttcctt ttattcttga
atggctgctt atggtgacaa tcatagattg ttatcataaa
gcgagttgga ttggccatcc agt

Synthesis of the Magnetic Particles Conjugated to Capture Oligonucleotide

5×10¹⁴ copies of a solution of capture oligonucleotide complementary to the PCR products to be detected are added to 100 μl of streptavidin-magnetic particles obtained as is described in Example 2. The capture reaction takes place for 30 minutes at 37° C. with shaking. The latex beads are then washed by magnetization and taken up in borate buffer, before being deposited in the form of spots into the wells of a microtitration plate with the capillary depositing device described above. Magnets are placed under the wells before deposition.

Capture of the Amplicons on the Spots of Magnetic Latex Beads

The amplicons are denatured for 5 minutes at 94° C. and are then added to the wells comprising the spots of latex beads. The hybridization reaction takes place for 30 minutes at 37° C. with shaking. The wells are then rinsed with PBS-Tween buffer.

Detection of the Biotinylated PCR Products

A solution of streptavidin-fluorescein at 0.1 mg/ml in PBS-Tween/0.2% BSA is prepared. 30 μl of this solution are added to each well. Non-specific controls are obtained on wells which have not been subjected to hybridization of the PCR products. The incubation takes place for 30 minutes at 37° C. with shaking. The wells are then rinsed in PBS-Tween buffer and then in ammonium carbonate buffer, before being airjet-dried and analysed under a fluorescence microscope.

Results

Two images show spots obtained, respectively, in the presence and in the absence of the amplicons. The first image shows a spot of homogeneous and relatively strong intensity, which clearly proves the presence i) of specific capture of the amplicons on the support magnetic particles and ii) of efficient detection of these biotinylated amplicons by the streptavidin. It is confirmed here that the use of magnetized magnetic latex beads makes it possible to obtain a uniform distribution of the particles and therefore of the detection signal within the spot, without any crown effect, which considerably simplifies the image analysis required for quantification of the fluorescence emitted.

With the process according to the invention, it is possible to deposit several spots, juxtaposed but separated from one another on the same flat support, just as it is possible to superimpose several spots one on top of the other.

By way of indication, as regards the molecular determination of a nucleic acid material, for example of the bacterial type, in accordance with French patent FR 2 797 690 (the content of which is incorporated into the present description as required), each transporting particle associates, in the form of a complex:

a magnetic particle comprising the magnetic support, a first ligand (oligonucleotide specific for a nucleic acid target) and a fluorophore label;

a non-magnetic particle comprising a non-magnetic support, and another fluorophore label, together constituting the product of interest, bound to the nucleic acid target via a second ligand (other oligonucleotide specific for the nucleic acid target, in another region).

The process according to the invention can be used for printing or depositing a paint on any surface positioned in a magnetic field.

1. Process for depositing, on a substrate (1), at least a predetermined amount of at least one product of interest (2), distributed at the surface (1a) of the substrate and delimited according to a basic area (3), which has a low value, referred to as a “spot”, according to which process:
(a) a liquid medium (4), comprising a vehicle and the product of interest (2) homogeneously distributed in said vehicle, is prepared or is available;
(b) a drop (5) is formed from the liquid medium, the volume of which drop is determined in relation to the predetermined amount of the product of interest to be deposited, and said drop is placed onto the surface (1a) of the substrate, in contact with the liquid medium;
(c) the vehicle is removed at least partially from the drop (5), while it remains on the surface (1a) of the substrate (1), for example by drying, so as to allow said spot (3) to remain;
characterized in that, in combination:
(1) a magnetic support (6), distributed homogeneously in the form of particles in the vehicle, is prepared or is available;
(2) the product of interest (2) is bound to the magnetic support (6), as a result of which the liquid medium, from which the drop (5) is formed, comprises transporting particles (7) distributed in the vehicle, each one comprising both the magnetic support (6) and the product of interest (2);
(3) at least during the removal of the vehicle from the drop (5), a magnetic field (8) is generated which crosses the surface (1a) of the substrate (1) according to a section (1c) comprising, and larger than, the area of contact (1d) between the drop (5) and the substrate (1), as a result of which the spot (3) obtained comprises the transporting particles (7), and therefore the product of interest (2), according to a homogeneous surface distribution.

2. Process according to claim 1, characterized in that the product of interest (2) is a ligand, for example an oligonucleotide for capturing a target nucleic acid.

3. Process according to claim 1, characterized in that the product of interest (2) is bound to the magnetic support (6), in the form of particles, by functionalization of said support and then bonding, for example covalent bonding, between the functionalized support and the product of interest.

4. Process according to claim 1, characterized in that the substrate (1) is a wall of a microtitration or microanalysis well.

5. Method for isolating, for example for determining, an analyte, characterized in that the product of interest (2) is a ligand specific for an analyte, and a substrate which can be obtained using a process according to any one of claims 1 to 4 is used.

6. Device for isolating, for example for determining, an analyte, characterized in that it comprises or incorporates a well, at least a part of the wall of which, for example the bottom thereof, constitutes a substrate on which is deposited at least one spot which can be obtained using a process according to any one of claims 1 to 4.
